(19) United States
(12) Patent Application Publication
(10) Pub. No.: US 2017/0201533 A1
(43) Pub. Date: Jul. 13, 2017

(54) MOBILE AWARE INTRUSION DETECTION SYSTEM

(71) Applicant: T-Mobile USA, Inc., Bellevue, WA (US)

(72) Inventors: Yousif Targali, Sammamish, WA (US); Karunakalage Viraj Rakitha Silva, Renton, WA (US); James Michael Bangsberg, Shoreline, WA (US)

(21) Appl. No.: 15/082,692

(22) Filed: Mar. 28, 2016

Related U.S. Application Data
(60) Provisional application No. 62/277,945, filed on Jan. 12, 2016.

(51) Int. Cl. H04L 29/06; H04L 29/08; H04L 29/12

(52) U.S. Cl. CPC H04L 63/1416; H04L 69/22; H04L 61/2007; H04L 67/24; H04L 63/1441; H04L 63/02

(57) ABSTRACT

A method and system of detecting a source of an intrusion in a mobile network. A data packet is captured of a plane traffic of a user device that is using the mobile network. The data packet has a header portion and a payload. The payload is inspected for a security event. Upon determining a presence of the security event, a unique session identifier is extracted from the header portion of the data packet. A source of the security event is identified based on the extracted unique session identifier.

### CROSS REFERENCES TO RELATED APPLICATIONS

The present application claims the benefit of priority under 35 U.S.C. §119 from U.S. Provisional Patent Application Ser. No. 62,277,945, entitled “Mobile Aware Intrusion Detection System,” filed on Jan. 12, 2016, which is hereby incorporated by reference in its entirety for all purposes.

### BACKGROUND

In recent years, mobile wireless communications have become increasingly popular. The rapid proliferation of wireless networks and mobile computing applications has put additional demands on network security. The character of mobility introduces vulnerabilities that do not exist in traditional fixed networks. Accordingly, many security measures that are effective for a fixed network may be inadequate for a mobile network. Unlike fixed (e.g., wired) networks that operate on a fixed IP plane, wireless networks include multiple planes, such as the management plane, control plane and the user plane, which make traceability of a source of a communication more difficult after the payload is evaluated for malicious activity. Since tracking down a source of a data communication (e.g., a user device) in a large network is a challenge, attacks by a compromised user device using the wireless network can have damaging consequences. Further, quarantining or blocking the offending user device is a challenge.

While intrusion detection systems (IDS) exist and may be effective in fixed networks, such systems fail to identify a source of a data communication in a wireless network. It is with respect to these considerations and others that the present application has been made.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture for implementing a mobile-aware intrusion detection system including user plane traffic.

FIG. 2, which illustrates an example architecture for implementing a mobile-aware intrusion detection system including control plane traffic.

FIG. 3 illustrates an example architecture for implementing a mobile-aware intrusion detection system consistent with a first option.

FIG. 4, which illustrates an example call flow for identifying the source of a malicious activity using the first option.

FIG. 5 illustrates an example architecture for implementing a mobile-aware intrusion detection system consistent with a second option.

FIG. 6 illustrates an example call flow for identifying the source of a malicious activity using the second option.

FIG. 7 illustrates an example architecture for implementing a mobile-aware intrusion detection system consistent with a third option.

FIG. 8, which illustrates an example call flow for identifying the source of a malicious activity using the third option.

FIG. 9 illustrates a table providing an example mapping of session/tunnel identifiers to user identifiers.

FIG. 10 illustrates an example create session request from which user and session/tunnel information are extracted.

FIG. 11 illustrates an example create session response from which user and session/tunnel information are extracted.

FIGS. 12 and 13 provide the GTP header format for 3GPP standards.

FIG. 14 provides a functional block diagram illustration of an example computer hardware platform that is used to implement a MAID system.

### DETAILED DESCRIPTION

### Overview

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

This disclosure is directed to an intrusion detection system (IDS), and more particularly, a mobile-aware IDS for wireless and mobile networks. An IDS is a hardware device or software application that is configured to monitor network or system activities for malicious activity or policy violations. While IDS solutions may be effective in identifying a source of a malicious activity (sometimes referred to herein as a security event) in fixed network environments, similar IDS tools are not adequate for wireless networks. The substantial differences between the fixed network and a mobile network makes it difficult to apply IDS techniques to determine the source of the malicious activity, contain the source of the malicious activity, and possibly provide a solution therefor. While a fixed network performs its activity on a single plane (e.g., Internet Protocol (IP) space), a mobile network does not have a fixed infrastructure. Instead, a mobile network operates on multiple planes.

As used herein, a plane is one of three components of a telecommunications architecture, namely the user plane, the control plane, and the management plane. These planes can be interpreted as different aspects of a communication network, each carrying a different type of traffic.

For example, a user plane (sometimes referred to as a data plane) carries the network user traffic. A data packet traveling on a user plane includes a header portion and a payload. The header portion includes information regarding the source of the payload. On the other hand, a control plane carries signaling traffic. Control data packets originate from or are destined for a router. The control plane includes a header portion but not a payload portion. It should be noted that known IDS′s are generally not motivated to inspect control plane traffic because a payload, which may include a security threat, is not included. As to the management plane, it carries administrative traffic, which is considered a subset of the control plane.

### Example High Level Architecture

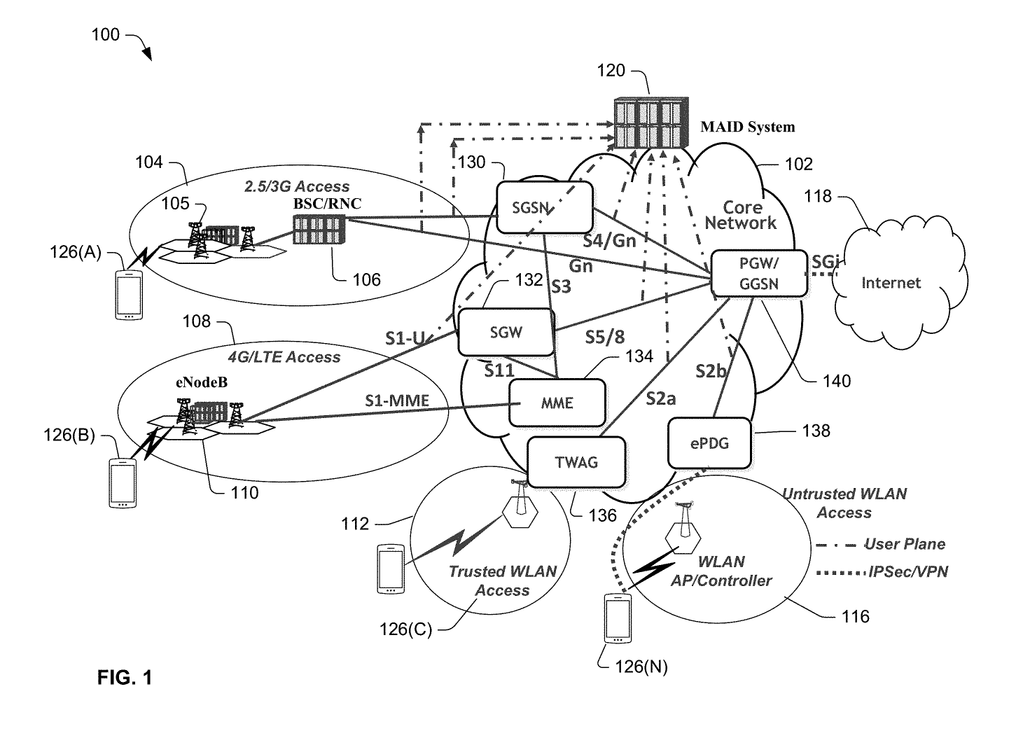

FIG. 1 illustrates an example architecture 100 for implementing an intrusion detection system including user plane traffic. Architecture 100 includes a core network 102 that allows various user devices 126(A) to 124(N) to communicate with each other as well as any other components that are connected to the core network 102. Today, user devices typically take the form portable handsets, smart-phones, tablet computers, personal digital assistants (PDAs), and smart watches, although they may be implemented in other form factors, including consumer, business, and medical electronic devices.

The core network 102 may be a packet data communication network as may be operated by a carrier or service provider to provide a wide range of mobile communication services and ancillary services or features to its subscriber customers and associated user devices. The user devices can access the mobile network via various networks, such as a 2.5/3G access network 104, a 4G/LTE access network 108, a trusted wireless local (WLAN) area network 112, and/or an untrusted WLAN (116). The core network 102 enables a user device to communicate with other user device in the mobile network or another host/server on the Internet 118. For example, an SGi interface may couple the core network 102 to the Internet 118.

Each access network provides its own access platform. For example, the 2.5/3G access network 104 includes a base station controller (BSC) and/or a radio network controller (RNC) 106. A BSC provides control of and supervises a number of base transceiver stations (BTS) 105. An RNC is a guiding element of a universal mobile telecommunications (UMTS) radio access network (UTRAN) governing element in the UMTS radio access network (UTRAN) and controls the Node Bs that are connected to it. For example, a Node B is similar to a base transceiver station used in a global system for mobile communication (GSM). The BSC 106 couples with the serving general packet radio service (GPRS) support node (SGSN) 130, which is responsible for the delivery of data packets from and to the user device 126(A). The SGSN connects to the Gateway GPRS Support Node (GGSN) 140 via Gn interface and connects to the Packet Data Network Gateway (PGW) 140 using S4 interface. The Gn/S4 interface between SGSN 130 and PGW/GGSN 140 can carry both user plane and control plane traffic. The RNC 106 can also connect directly to the GGSN 140 with a Gn interface, which carries only user plane traffic in this case.

The 4G/LTE access network 108 includes one or more evolved Node B′s (eNodeB's) that provides an interface between a user device (e.g., 126(B)) and the core network 120. The eNodeB 110 couples with the core network 102 via the mobility management entity (MME) 134, which is a control-node. For example, it is used for idle mode user device tracking and paging procedure including retransmissions. It also provides bearer channel activation/deactivation process and selection of the serving gateway (SGW) 132 for the user device 126(B). The MME 134 provides authentication of the user by interacting with the Home Subscriber Server (HSS)-not shown. There is an S1-U interface between eNodeB 110 and SGW 132, which carries user plane traffic. There is an S1-MME interface between the eNodeB 110 and MME 134, which provides a reference point for the control plane protocol between E-UTRAN and MME.

Various user devices may also access the core network 102 via trusted WLAN 112, which may be found in a home network, or an untrusted WLAN 116, which may be found in a public area. In a trusted access, the user device is connected through a Trusted Wireless Access Gateway (TWAG) 136 in the core network 136. The TWAG 136 is in turn connected directly with the Packet Gateway (P-GW) 140 through a secure tunnel (GTP, MIP or PMIP), provided by S2a.

In an untrusted access, the user device (e.g., 106(N)) is connected directly to the Evolved Packet Data Gateway (ePDG) 138 through an Internet protocol security (IPSec) tunnel. The ePDG is connected to the P-GW 140 connection where each user session is transported through a secure tunnel (e.g., S2b).

There are different interfaces between the different components of the core network 102. For example, between SGSN 130 and PGW 140, there is an S4/Gn interface, which carries both user plane and control plane traffic. Between SGSN 130 and MME 134 there is an S3 interface, which enables user and bearer information exchange for inter 3GPP access network mobility in idle and/or active state. The S3 interface carries control traffic. Between the SGW 132 and the PGW 140 there is an S5/8 interface, which carries both user plane and control plane traffic. For example, the S5 interface provides user plane tunneling and tunnel management between SGW 132 and PGW 140. It is used for SGW 132 relocation due to user device mobility.

Between the MME 134 and the SGW, there is an S11 interface, which carries control plane traffic. Between the TWAG 136 and the PGW 140 there is an S2a interface, which carries both user plane and control plane traffic. Between the ePDG 138 and the PGW 140 there is an S2b interface, which carries both user plane and control plane traffic.

The example of FIG. 1 illustrates the mobile-aware intrusion detection (MAID) system block 120 receiving information from the user plane traffic sources, represented by the solid lines having an arrow leading to the MAID system 120. In various embodiments, the MAID system 120 may be implemented by one or more servers that are configured to determine specific information from various communication planes to help determine whether the data communication involves malicious activity as well as the source of the malicious activity. The different options performed by the MAID system 120 are discussed in detail later.

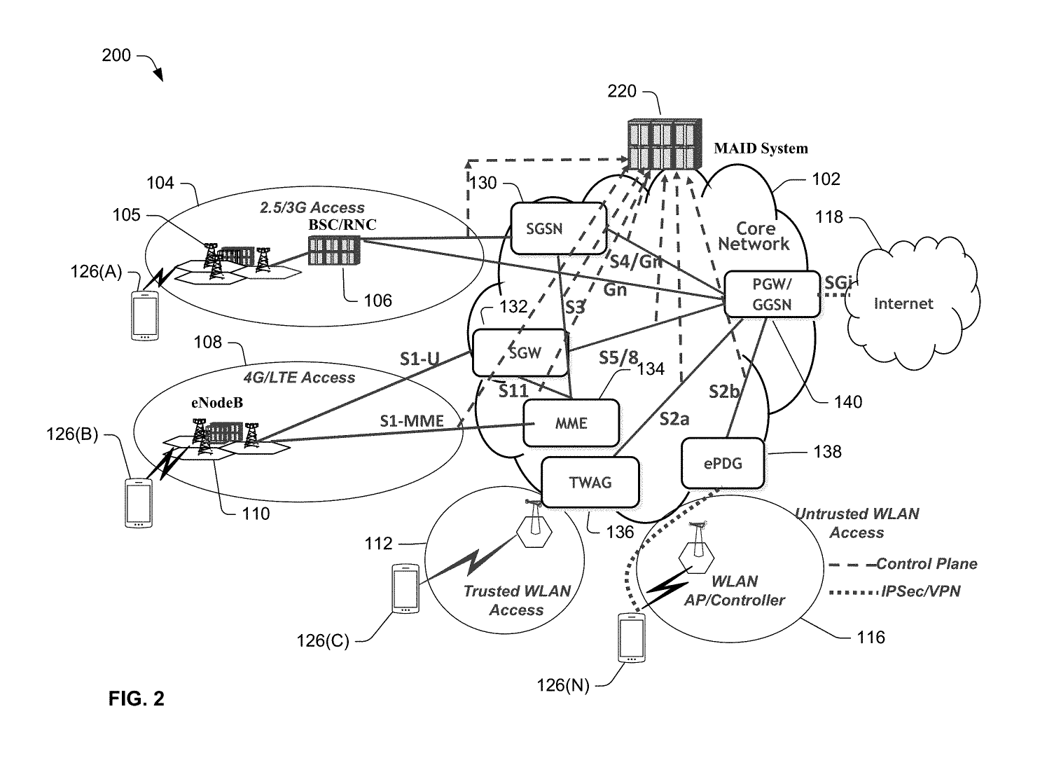

Reference now is made to FIG. 2, which illustrates an example architecture 200 for implementing an intrusion detection system including control plane traffic. The components of the architecture of FIG. 2 are substantially similar to those of FIG. 1 and are therefore not repeated here for brevity. FIG. 2 highlights that MAID system 220 receives information from various control plane traffic sources, represented by the dashed lines leading to the MAID system 200.

For example, one control plane traffic source may be the interface between the BSC/RNC 106 and the SGSN 130 Gb/lu-PS interface. The MAID system 220 receives information from this interface in order to extract the unique session internal information from the header portion. Similarly, the MAID system 220 may receive information from the S1-MME interface between the eNodeB 110 and the MME 134, the S3 interface between the SGSN 130 and the MME 130, the S11 interface between the SGW 132 and the MME 134, the S4/Gn interface between the SGSN 130 and the PGW/GGSN 140, the S5/8 interface between the SGW 132 and the PGW/GGSN 140, the S2a interface between the TWAG 136 and the PGW 140, and the S2b interface between the ePDG 138 and the PGW/GGSN 140. The unique session internal information from the header portion received from these identified various sources ultimately provides indicia on the offending user device (i.e., source of a security event), such that appropriate security measures may be performed. For example, the offending user device may be isolated, blocked, sent a warning, etc.

### MAID Functional Operation

The MAID system discussed herein provides different options for enhancing an intrusion detection system of a core network 102. More particularly, among other features, the MAID system facilitates the determination of the source (e.g., the user device) of the malicious activity. To that end, various options may be used. By way of example, the MAID system is discussed via a first option (A,) a second option (B), and a third option (C), each described in detail below.

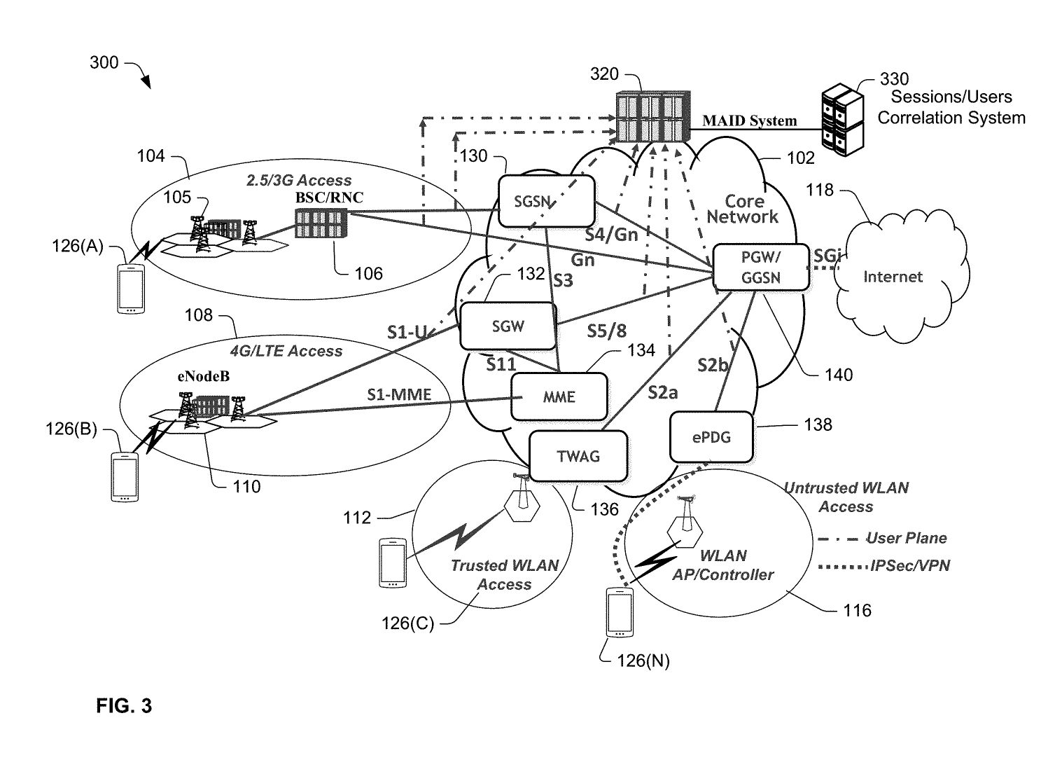

FIG. 3 illustrates an example architecture 300 for implementing a mobile-aware intrusion detection system consistent with a first option (A). The components of the architecture of FIG. 3 are substantially similar to those of FIG. 1 and are therefore not repeated here for brevity. FIG. 3 includes a session/users correlation system 330, which may be implemented as one or more servers that are configured to perform various functions, including to perform correlations based on the information received from the MAID system 320, providing binding tables, and taking appropriate action when malicious activity is detected (e.g., by the MAID system 320).

In the example of FIG. 3, in one embodiment, the MAID system 320 forwards security events of interest (e.g., identified malicious activity) including the unique session/tunnel identifiers to another system, represented by the correlation system 330, which may be part of the provider of the core network 102. The unique session/tunnel identifiers may include the tunnel endpoint identifier (TEID), which is a 32-bit field used to multiplex different connections in the same GPRS tunneling protocol (GTP) tunnel. The unique session/tunnel identifiers may also include the Internet protocol (IP) address of the user device originating the malicious data leading to the malicious activity.

Unlike conventional approaches, the MAID system instructs the IDS to not immediately strip off the header from the received data packet; rather, the IDS extracts the unique session internal information from the header portion. It may then separate the header portion from the payload of the received data. By virtue of retaining the header information, which includes user device identification information, the user device originating the malicious activity may be traced.

In one embodiment, the MAID system 320 then sends both pieces of information (i.e., the extracted header portion and the payload) to the correlation system 330. In one embodiment, the MAID system 320 only sends the two pieces of information to the correlation system upon determining that a security event has occurred.

The correlation system 330 includes one or more tables of biding sessions/tunnel identifiers and user identifiers. The correlation system 330 is configured to provide correlations based on the header information and the payload received from the MAID system. More particularly, the correlation system performs a correlation between the unique session identifier and the unique user device identification information. (Unique session identifiers may include, without limitation, TEID, IP address, etc. Unique user device identifiers may include, without limitation, IMSI, MSISDN, IMEI, etc.) Put differently, the correlation system 330 provides the identity of the owner (i.e., account holder) of the user device by identifying the user device.

In various embodiments, upon identifying the user device, and by extension the owner of the user device, the correlation system 330 may take different actions. For example, a notification may be sent to an appropriate recipient (e.g., account holder, system administrator, user device, etc.). The notification may be sent in various ways, such as common short code (CSC) using a short message service (SMS), multimedia message service (MMS), e-mail, telephone, social media, etc. Alternatively or in addition, further traffic originating from and/or destined to the user device identified of being the source of the malicious activity may be blocked.

### Example Call Flow for First Option (A)

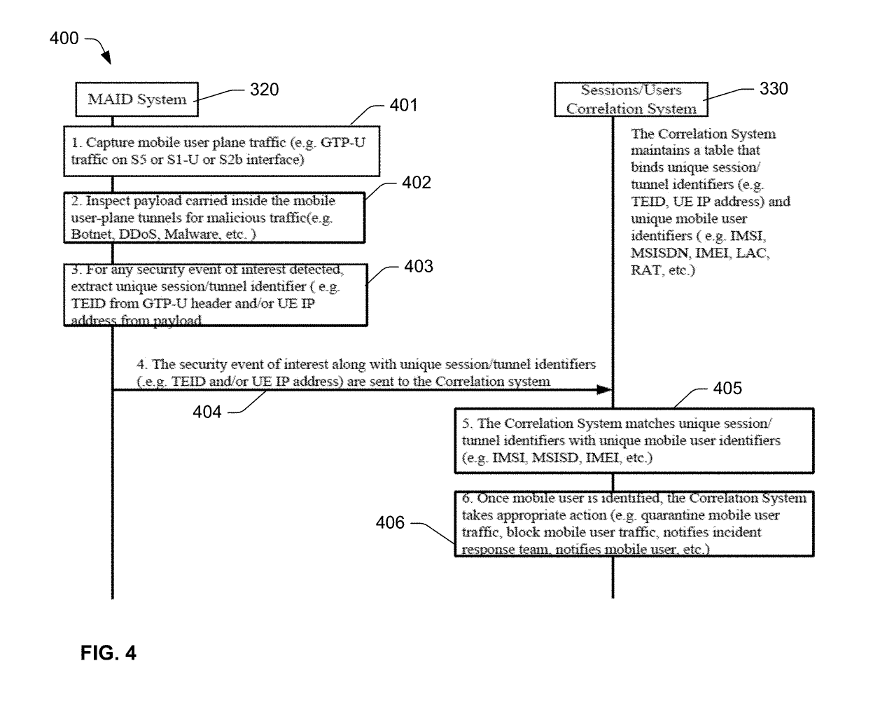

Reference now is made to FIG. 4, which illustrates an example call flow for identifying the source of a malicious activity using the first option (A). Process 400 is illustrated as a collection of blocks in a logical call flow, which represents a sequence of operations that can be implemented in hardware, software, or a combination thereof In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or performed in parallel to implement the process. Similar concepts apply to subsequent call flows discussed herein. For discussion purposes, the process 400 is described with reference to the architecture 300 of FIG. 3.

At block 401, the MAID System 320 captures the user device plane traffic. For example, such user device plane traffic may be based on the GTP-U protocol, which is used for carrying user data within the GPRS core network and between the radio access network and the core network. Accordingly, an Gb/lu-PS, S1-U, S4/Gn, S5/8, S2a, or S2b interface may be used.

At block 402, the MAID system 320 inspects the payload carried inside the mobile user-plane tunnels for malicious activity (e.g., traffic), such as Botnet, distributed denial of service (DDoS), Malware, and the like, referred to herein as a security event.

At block 403, upon determining that a security event has occurred, a unique session/tunnel identifier is determined. For example, the unique session/tunnel identifier may be the TEID from GTP-U header and/or user device internet protocol IP address where the payload originated.

At block 404, a data inquiry packet is sent to the correlation system 330. In various embodiments, the data inquiry packet may include an indicia of the identified security event of interest and one or more unique session/tunnel identifiers (e.g., TEID and/or user device IP address). It should be noted that the security event may include: Attack name (e.g., Botnet, Phishing, HTTP attack, Buffer overflow, TCP scan, UDP scan, etc.); Attack category (e.g. Exploit, Reconnaissance, Policy Violation, DDoS, Malware, etc.); Attack severity (e.g. High, Medium, Low); Source IP, Destination IP, Source Port, Destination port, and the like. In addition, for some types of attacks, the payload associated with the security event of interest may be sent as well.

The correlation system is configured to maintain a table that binds unique session/tunnel identifiers (e.g., TEID, user device IP address) and unique mobile user identifiers, such as international mobile subscriber identity (IMSI), mobile station international subscriber directory number (MSISDN), international mobile station equipment identity (IMEI), location area identity (LAC), radio access technology (RAT), and the like.

At block 405, the correlation system 330 matches the one or more unique session/tunnel identifiers with a unique mobile user identifier (e.g., IMSI, MSISD, IMEI, etc.).

At block 406, upon identifying the user device, the correlation system 330 takes appropriate corrective action, which may include quarantining traffic from/to the user device, blocking traffic from/to the user device, and sending out notifications (e.g., to an account holder, a system administrator, user of the user device, etc.). For example, when traffic is blocked, it may already be known to be bad. When traffic is quarantined, traffic is suspicious and is further analyzed and monitored to decide whether (i) it is indeed bad and should be blocked, (ii) it should be temporarily blocked, and/or (iii) it is clean and should not be blocked.

### MAID Functional Operation—Second Option (B)

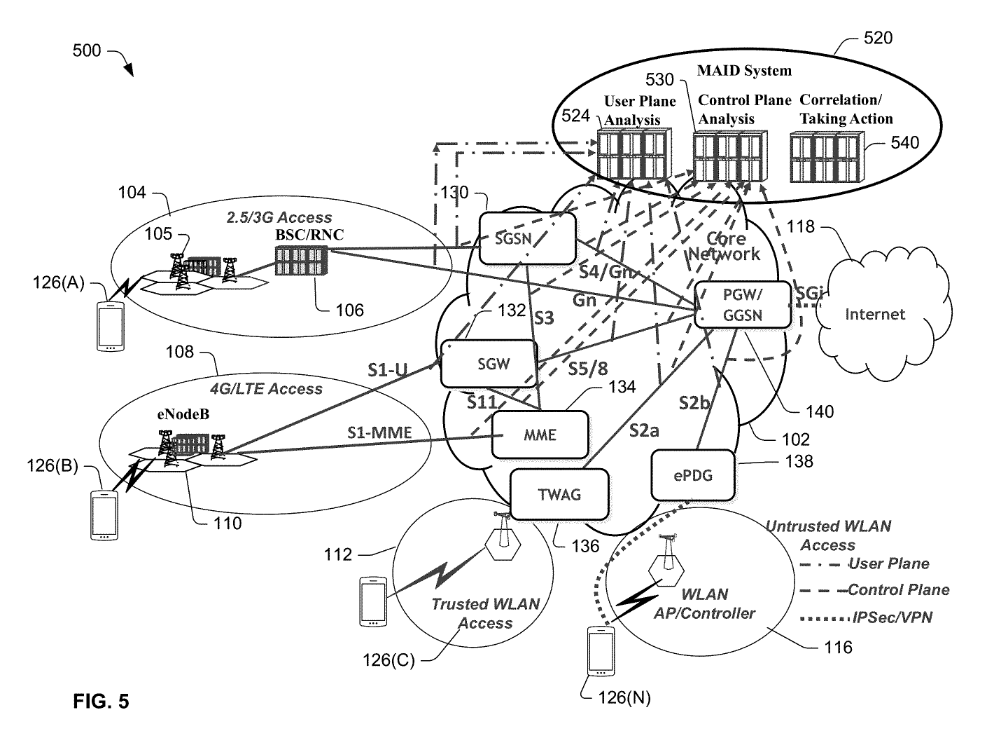

FIG. 5 illustrates an example architecture 500 for implementing an intrusion detection system consistent with a second option (B). The components of the architecture of FIG. 5 are similar to those of FIG. 2 and are therefore not repeated here for brevity. In FIG. 5, the MAID system 520 includes a user plane analysis component 524, a control plane analysis component 530, and a correlation and taking actions component 540.

In the example of FIG. 5, the user plane analysis component 524 of the MAID system 520 is configured to extract unique session/tunnel identifiers (e.g., TEID, IP address, etc.) from the header portion of a of a captured data packet. The user plane analysis component 524 is configured to analyze user plane traffic while the control plane analysis component 530 is configured to analyze control plane traffic for malicious activity. For example a user device, such as user device 126(B) may communicate with the SGW 132 via an S1-U channel The user plane analysis component 524 of the MAID system 520 captures this data packet of this user plane traffic to perform analysis thereon. In another example, the user device 126(B) may communicate with the MME 134 via an S1-MME channel. In this regard, the control plane analysis component 530 captures this data packet of the control plane traffic to perform analysis thereon.

In each example above, the user plane analysis component 524 and the control plane component 530 extract unique user identifiers, such as IMIS, MSISDN, IMEI, LAC, RAT, and the like from the header portion of the corresponding data packet. The correlation and taking actions component 540 of the MAID system 520 is configured to correlate security events of interest, unique session/tunnel identifiers, and unique user identifiers, as discussed in the context of FIG. 3 above.

### Example Call Flow for Second Option (B)

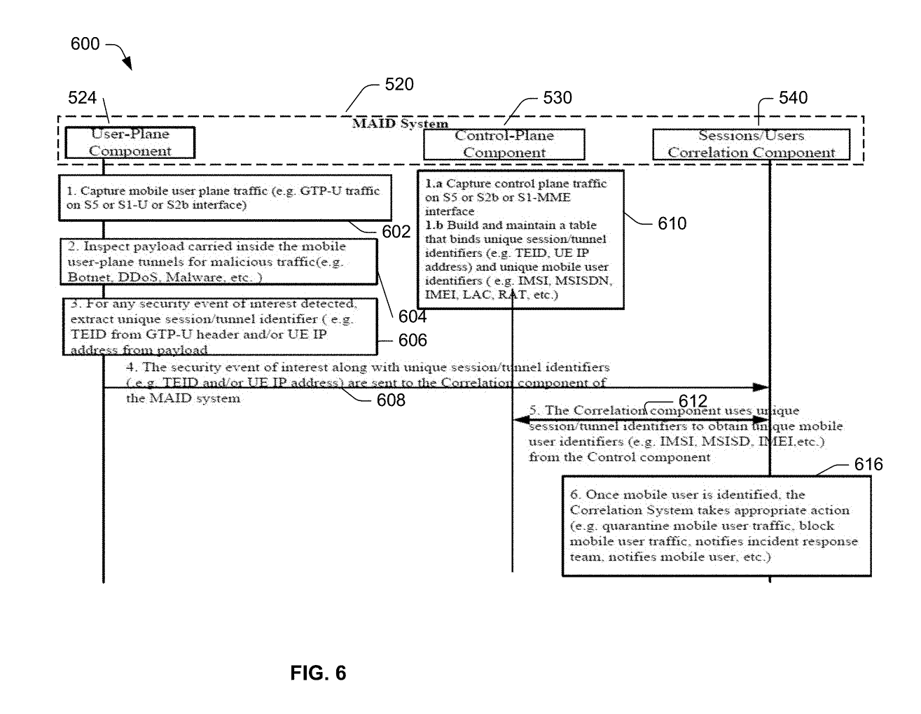

Reference now is made to FIG. 6, which illustrates an example call flow for identifying the source of a malicious activity (e.g., a security event) using the second option (B). For discussion purposes, the process 600 is described with reference to the architecture 500 of FIG. 5. Process 600 includes a MAID system 520 that comprises a user plane component 524, a control plane component 530, and a sessions/users correlation component 540, similar to those of FIG. 5.

At block 602, the user plane component 524 of the MAID System 520 captures the user device plane traffic (e.g., GTP-U traffic on S5 or S1-U or S2b interface).

At block 604, the user plane component 524 of the MAID system 520 inspects the payload portion of the data packet carried inside the mobile user-plane tunnels for malicious activity (e.g., traffic), such as Botnet, DDoS, Malware, and the like, referred to herein as a security event.

At block 606, upon determining that a security event has occurred, the user plane component 524 of the MAID system 520 determines, a unique session/tunnel identifier. For example, the unique session/tunnel identifier may be the TEID from GTP-U header and/or user device internet protocol (IP) address of where the payload originated.

At block 608, a data inquiry packet is sent to the correlation system 540 of the MAID system 520. In various embodiments, the data inquiry packet may include an indicia of the identified security event of interest and one or more unique session/tunnel identifiers (e.g., TEID and/or user device IP address).

In one embodiment, the correlation system component 540 of the MAID system 520 is configured to maintain a table that binds unique session/tunnel identifiers (e.g., TEID, user device IP address) and unique mobile user identifiers, such as IMSI, MSISDN, IMEI, LAC, RAT, and the like.

Similar to the user plane component 524, the control plane component 530 of the MAID system 520 captures control plane traffic on an S5, S2b, or S1-MME interface (i.e., block 610). The user plane component 524 also builds and maintains a table that binds unique session/tunnel identifiers, such as TEID, UE IP address, and the like, and the control component 530 builds and maintains a table of unique mobile user identifiers, such as IMSI, MSISDN, IMEI, LAC, RAT, and the like for all of the mobile users.

At block 612, upon having a security event of interest, the sessions/users correlation component 540 uses a unique session/tunnel identifier (e.g. TEID, UE IP, etc.) to obtain a unique mobile user identifier (e.g., IMSI, MSISDN, IMEI, etc.) from the control plane component 530.

At block 616, upon identifying the user device, the correlation component 540 of the MAID system 520 takes appropriate action, which may include quarantining the user device traffic, blocking traffic to/from the user device, and sending out notifications (e.g., to an account holder of the user device, a system administrator, user of the user device, etc.).

### MAID Functional Operation—Third Option (C)

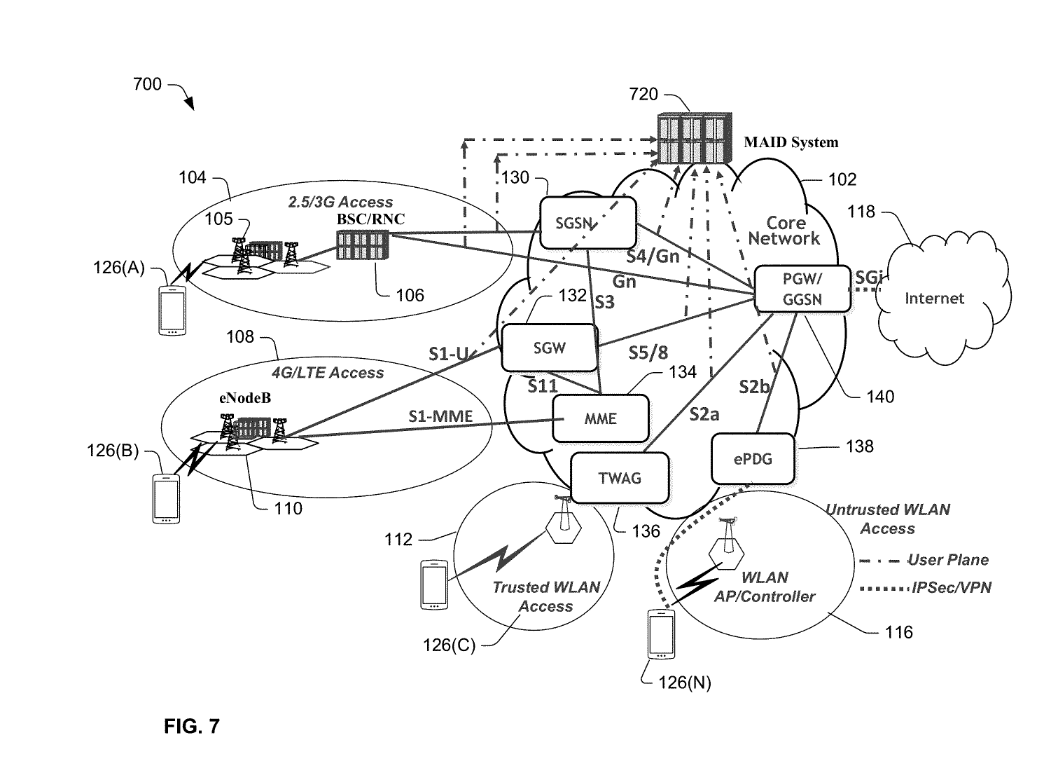

FIG. 7 illustrates an example architecture 700 for implementing an intrusion detection system consistent by way of a third option (C). The components of the architecture of FIG. 7 are similar to those of FIG. 1. It is also noted that the architecture 700 differs from the architecture 300 in that the architecture 700 does not include a sessions/users correlation system 330.

In the example of FIG. 7, the MAID system 720 is configured to extract unique session/tunnel identifiers (e.g., TEID, IP address, etc.) for security events of interest detected. Mobile network elements, such as the SGSN 130, PGW/GGSN 140, SGW 132, MME 134, ePDG 138, are enhanced to include session/user correlation enablement functionalities by maintaining a table that binds unique session/tunnel identifiers (e.g. TEID, UE IP address, etc.) with user identifiers (e.g., IMSI, MSISDN,IMEI, etc.) and supporting an API to communicate and respond to MAID system queries and provide back unique user device identification information associated with unique session identifiers (e.g. TEID, UE IP address, etc.) received in the query from the MAID system. Accordingly, the correlation system is embedded in the MAID system 720 and is therefore not a separate component as in the example embodiment of FIG. 3.

The MAID system 720 of FIG. 7 is configured to use unique session/tunnel identifiers to query the correlation network elements (e.g., SGSN 130, PGW/GGSN 140, SGW 132, MME 134, etc.) for unique user information (e.g., IMSI, MSISDN, etc.). The MAID system 720 is also configured to take appropriate action based on the security event of interest detected and received user information, as discussed above.

### Example Call Flow for Third Option (C)

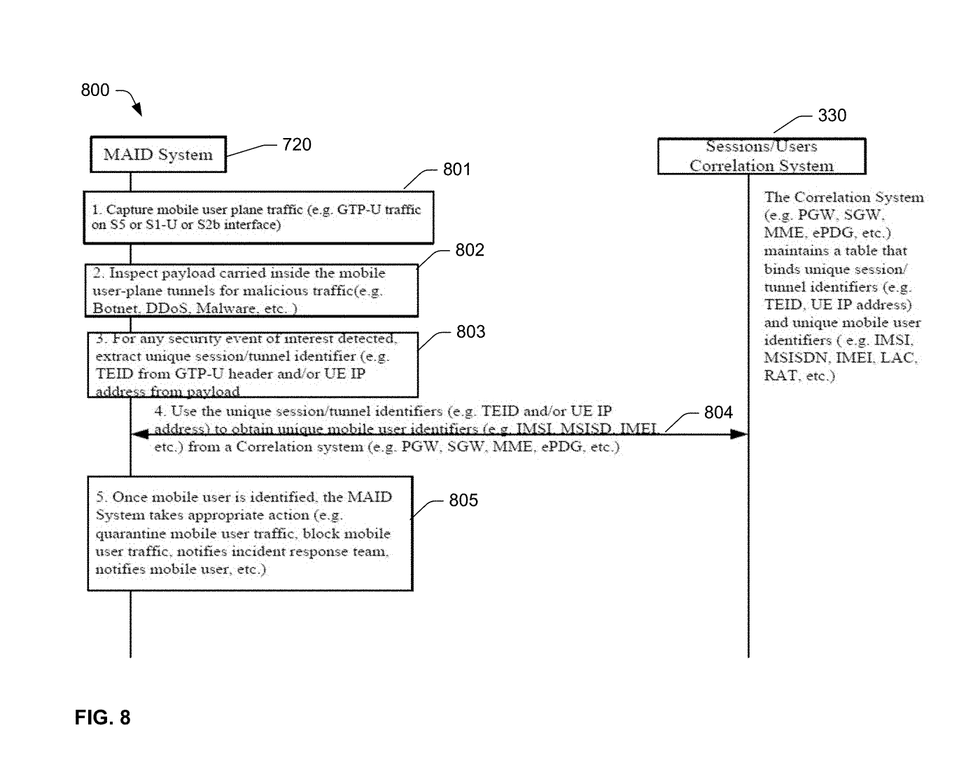

Reference now is made to FIG. 8, which illustrates an example call flow for identifying the source of a malicious activity using the third option (C). For discussion purposes, the process 800 is described with reference to the architecture 700 of FIG. 7. Process 800 includes the MAID system 720. In this option, mobile network elements, such as SGSN 130, PGW/GGSN 140, SGW 132, MME 134, ePDG 138, and TWAG 136, are enhanced to include session/user correlation functionality. These elements act as a correlation system by maintaining a table that binds unique session/tunnel identifiers (e.g., TEID, UE IP address, etc.) with user identifiers (e.g., IMSI, MSISDN,IMEI, etc.).

At block 801, the MAID System 720 captures the user device plane traffic. For example, such user device plane traffic may be based on the GTP-U protocol, which is used for carrying user data within the GPRS core network and between the radio access network and the core network. Accordingly, an S5, S1-U, or S2b interface may be used.

At block 802, the MAID system 720 inspects the payload carried inside the mobile user-plane tunnels for malicious activity (e.g., traffic), such as Botnet, DDoS, Malware, and the like, referred to herein as a security event.

At block 803, upon determining that a security event has occurred, a unique session/tunnel identifier is determined. For example, the unique session/tunnel identifier may be the TEID from GTP-U header and/or user device internet protocol IP address where the payload originated.

At block 804, the MAID system 720 sends a data inquiry packet requesting user information associated with the determined session/identifier to a network element in the core network 102 that has been enhanced with session/user correlation functionality (e.g. SGSN 130, PGW/GGSN 140, SGW 132, MME 134, ePDG 138, etc.). Put differently, one or more components of the core network 102, such as SGSN 130, PG2/GGSN 140, etc., have been enhanced to include the functionality of the correlation component discussed herein.

The network element enhanced with the correlation functionality is configured to maintain a table that binds unique session/tunnel identifiers (e.g., TEID, UE IP address) and unique mobile user identifiers, such as IMSI, MSISDN, IMEI, LAC, RAT, and the like. The network elements send back to the MAID system 720 user information (e.g., IMSI, MSISDN, IMEI, etc.) associated with the received session/tunnel identifier (e.g., TEID, UE IP, etc.).

At block 805, upon identifying the user device, the MAID system 720 takes appropriate action, which may include quarantining the user device traffic, blocking the user device traffic, and sending out notifications (e.g., to an account holder of the user device, a system administrator, user of the user device, etc.).

### Example Mapping Table

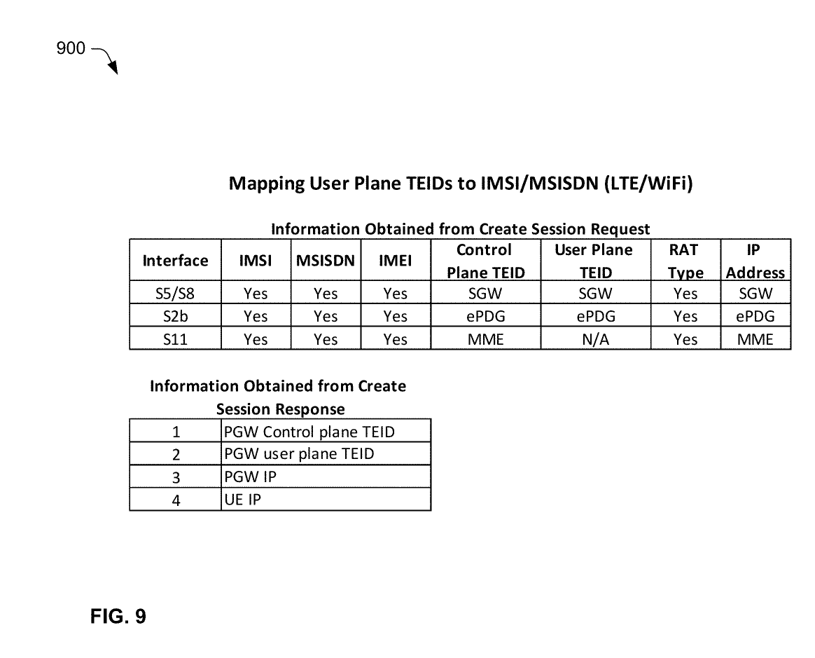

FIG. 9 illustrates a table providing an example mapping of a user plane TEIDs to user identifiers (e.g., IMSI, MSISDN, etc.). In particular, table 900 indicates what information can be extracted from a create session request from the s5/s8, s2b, and s11 interfaces to implement the functions discussed herein. In addition, table 900 indicates the information that can be extracted from a create session response.

### Example Create Session Request

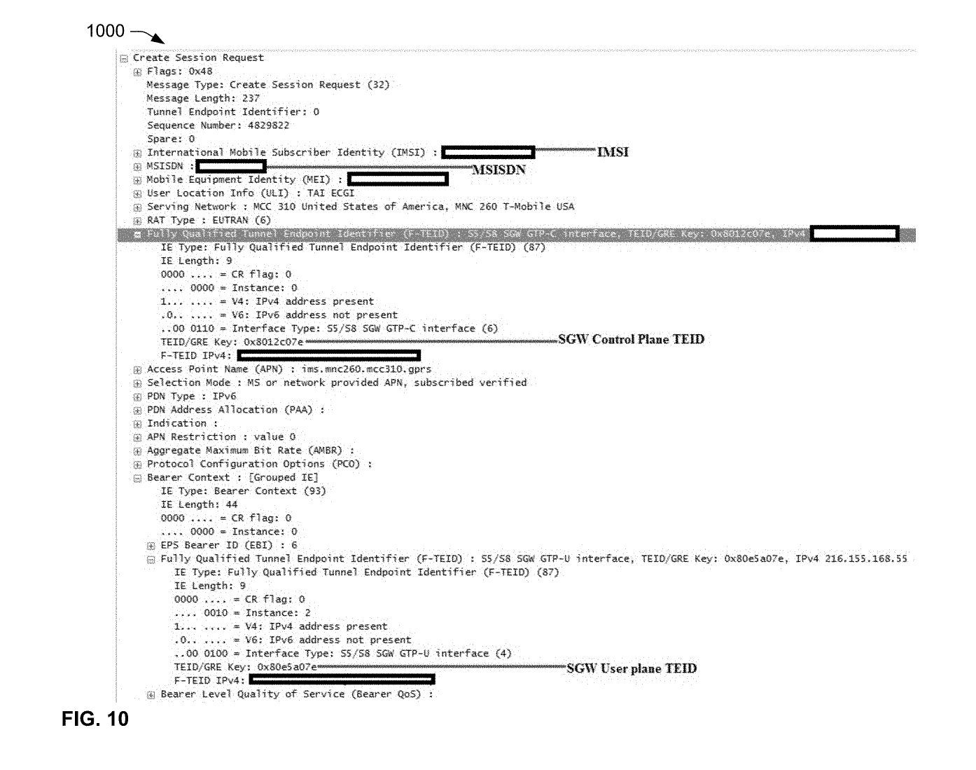

FIG. 10 illustrates an example create session request from which session/tunnel and user information can be extracted. In particular, FIG. 10 illustrates how and from which portions of the code the session/tunnel identifiers (e.g. TEID) and user identifiers (e.g. IMSI, MSISDN, and IMEI) can be located as information elements in the control plane message Create Session Request, for an S5 interface. Some fields in the code 1000 have been redacted for privacy.

### Example Create Session Response

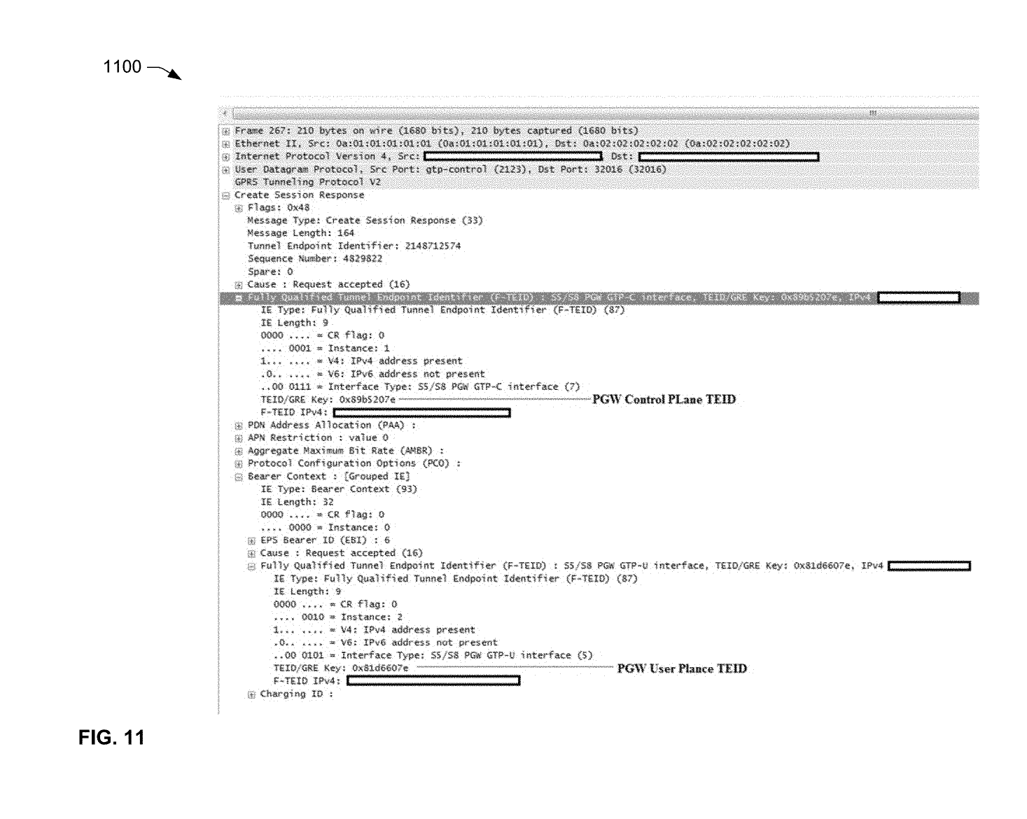

FIG. 11 illustrates an example create session response message on the control plane from which session/tunnel and user information can be extracted. In particular, FIG. 11 illustrates how and from which portions of the code the PGW TEID, PGW IP address, and UE IP address can be located in the create session response message on the control plane, for an S5 interface. Some fields in the code 1100 have been redacted for privacy.

### Header Format

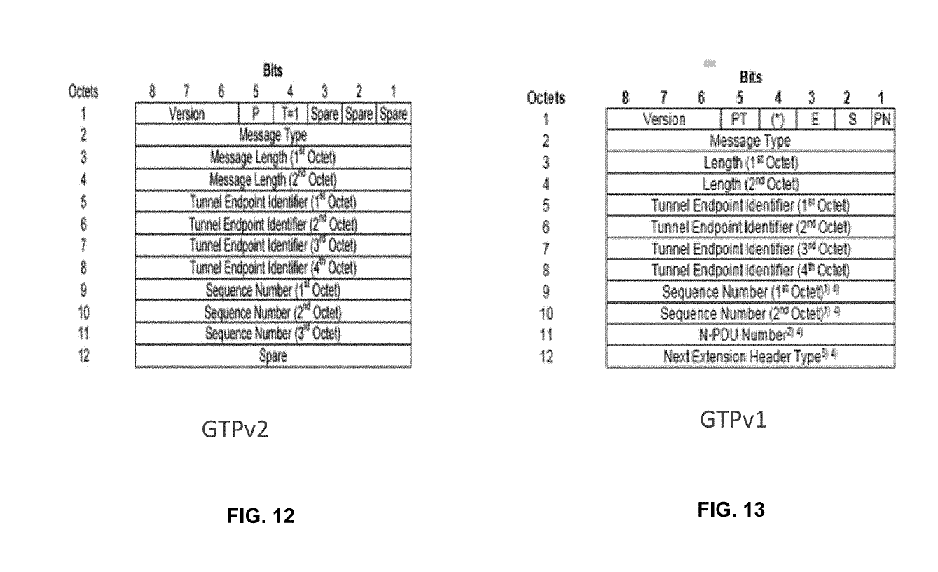

FIGS. 12 and 13 provide the GTP header format for 3GPP standards. FIGS. 12 and 13 indicate that, in one embodiment, octets 5 to 8 in the GTPv1 and GTPv2 can be used to extract Tunnel Endpoint identifiers.

### Example Computer Platform

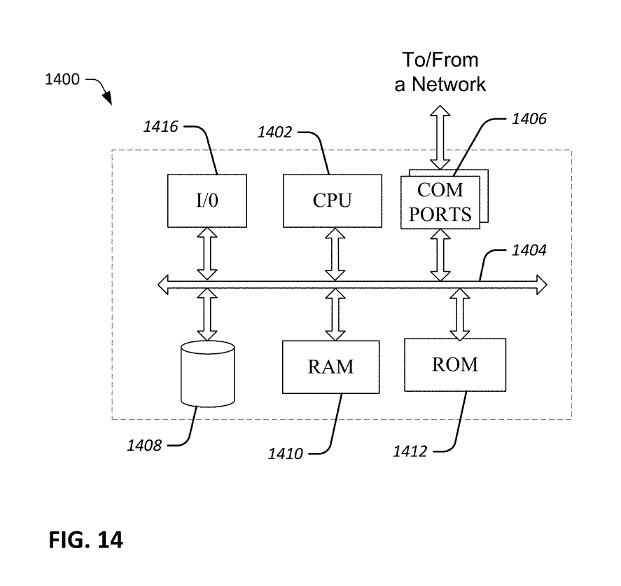

As discussed above, functions relating to a mobile aware intrusion detection system can be performed on one or more computing devices connected for data communication, as shown in FIGS. 1 to 3, 5, and 7, and in accordance with the processes of FIGS. 4, 6 and 8. In particular, FIG. 14 illustrates a network or host computer platform 1400, as may typically be used to implement a server. One or more of such servers may be used for the MAID system of FIGS. 1 to 3, 5, and 7, the sessions/users correlation system 330 of FIG. 3, etc. It is believed that the general structure and general operation of such equipment as shown in FIG. 14 should be self-explanatory from the high-level illustration.

A general purpose computer configured as a server, for example, includes a data communication interface 1406 for packet data communication. The server computer may include an I/O interface 1416 that may include a display, a touch screen, a keyboard, a pointing device, a microphone, a loudspeaker, and/or any other type of user interface device. The server computer also includes a central processing unit (CPU) 1402, in the form of one or more processors, for executing program instructions. The server platform typically includes an internal communication bus 1404, program storage 1408, and data storage for various data files to be processed and/or communicated by the server, although the server often receives programming and data via network communications. Data can be stored in various forms of computer-readable media, including (but not limited to) hard disk 1408, random access memory (RAM) 1410, read only memory (ROM) 1412, and the like.

The hardware elements, operating systems and programming languages of such servers are conventional in nature. Of course, the server functions may be implemented in a distributed fashion on a number of similar platforms, to distribute the processing load. In one embodiment, the functionality of the MAID system 320 and the sessions/users correlation system 330 may be combined in one or more server platforms. In one embodiment, the user plane analysis component 524, the control plane analysis component 530, and a correlation and taking actions component 540 of the MAID system 520 may be combined on one or more server platforms.

The software functionalities discussed herein involve programming, including executable code as well as associated stored data, e.g., information retrieved from the captured data packets from the user plane or control plane, to facilitate the determination of the source of a security event in a mobile network, as discussed herein.

The software code is executable by the corresponding computing device. In operation, the code is stored within the computing device. At other times, however, the software may be stored at other locations and/or transported for loading into the appropriate computing device system. Execution of such code by a processor of the computing device enables the computing device to perform the determination of the source of a security event in a mobile network, sending notifications to appropriate recipients, performed isolation/blocking of the offending user device, and other functions, as discussed herein. Hence, aspects of the intrusion detection system for a mobile network environment as outlined above may be embodied in programming Program aspects of the technology may be thought of as “products” or “articles of manufacture” typically in the form of executable code and/or associated data that is carried on or embodied in a type of non-transitory machine readable medium.

### CONCLUSION

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

Based upon design preferences, it is understood that the specific order or hierarchy of steps in the processes described herein may be rearranged, expanded, and some steps omitted. Some of the blocks may be performed simultaneously.

Unless otherwise stated, any measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The embodiments described herein may be implemented in software that runs on one or more computing devices. The one or more computing devices may be equipped with a communication interface, a user interface, one or more processors, and memory.

The communication interface of user devices may include wireless and/or wired communication components that enable the computing devices to transmit or receive data via a network, such as the Internet. The user interface may enable a user to provide inputs and receive outputs from the computing devices.

The user interface may include a data output device (e.g., visual display, audio speakers), and one or more data input devices. The data input devices may include, but are not limited to, combinations of one or more of keypads, keyboards, mouse devices, touch screens, microphones, speech recognition packets, and any other suitable devices or other electronic/software selection methods.

Each of the processors may be a single-core processor or a multi-core processor. Memory may be implemented using computer-readable media, such as computer storage media. Computer-readable media includes, at least, two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD), Blu-Ray, or other optical storage, magnetic cassettes, magnetic tape, magnetic disk storage or other magnetic storage devices, or any other non-transmission medium that may be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

What is claimed is:

1. An intrusion detection system for a mobile network, comprising:
a processor;
a network interface coupled to the one or more processors;
a storage device for content and programming;
a program stored in the storage device, wherein execution of the program by the processors configures the system to perform acts, comprising:
capturing a data packet of a plane traffic of a user device that is using the mobile network, wherein the data packet has a header portion and a payload;
inspecting the payload for a security event;
upon determining a presence of the security event:
extracting a unique session identifier from the header portion of the data packet; and
identifying a source of the security event based on the extracted unique session identifier.

2. The intrusion detection system of claim 1, wherein the unique session identifier of the data packet is at least one of a tunnel endpoint identifier (TEID) and an internet protocol (IP) address of the user device.

3. The intrusion detection system of claim 1, wherein execution of the program further configures the system to perform acts comprising: upon determining the presence of the security event, taking a corrective action.

4. The intrusion detection system of claim 3, wherein the corrective action includes sending a notification to at least one of:
an account holder of the user device;
a system administrator of the mobile network; and
the user device.

5. The intrusion detection system of claim 3, wherein the corrective action comprises isolating the user device by at least one of blocking traffic to and a traffic from the user device over the mobile network.

6. The intrusion detection system of claim 1, wherein identifying a source of the security event comprises:
sending a data inquiry packet comprising an indicia of the identified security event and the unique session identifier to a correlation system configured to correlate the unique session identifier with a unique mobile user identifier.

7. The intrusion detection system of claim 1, wherein identifying a source of the security event comprises:
sending the header portion and the payload of the data packet to a correlation system configured to correlate the unique session identifier with an account holder information of the user device; and
receiving an account holder information of the user device from the correlation system.

8. The intrusion detection system of claim 1, wherein determining a presence of the security event comprises: identifying at least one of: a botnet, a distributed denial of service (DDoS) attack, and malware.

9. The intrusion detection system of claim 1, wherein the system comprises:
a user plane analysis component configured to receive user plane traffic and to extract a unique session identifier from the header portion of the data packet;
a control plane analysis component configured to receive control plane user traffic and to inspect the payload for a security event; and
a correlation component configured to correlate the security event and the unique session identifier with a unique user information of the mobile network.

10. The intrusion detection system of claim 9, wherein:
the control plane analysis component is configured to capture control plane traffic on an S5, an S2b, and an S1-MME interface; and
the user plane component is configured to capture user plane traffic on an S2a, the S2b, an S3, an S4, a Gn, an S5, the S1-MME, an S11, and an S8 interface.

11. The intrusion detection system of claim 9, wherein the unique user information of the mobile network comprises at least one of an international mobile subscriber identity (IMSI), a mobile station international subscriber directory number (MSISDN), and an international mobile station equipment identity (IMEI).

12. A non-transitory computer-readable medium having stored thereon a program which, when executed by a processor, cause the processor to perform a method of detecting a source of an intrusion in a mobile network, the method comprising:
capturing a data packet of a plane traffic of a user device that is using the mobile network, wherein the data packet has a header portion and a payload;
inspecting the payload for a security event;
upon determining a presence of the security event:
extracting a unique session identifier from the header portion of the data packet; and
identifying a source of the security event based on the extracted unique session identifier.

13. The method of claim 12, wherein the unique session identifier of the data packet is at least one of a tunnel endpoint identifier (TEID) and an internet protocol (IP) address of the user device.

14. The method of claim 12, further comprising upon determining the presence of the security event, taking a corrective action.

15. The method of claim 14, wherein the corrective action includes sending a notification to at least one of:
an account holder of the user device;
a system administrator of the mobile network; and
the user device.

16. The method of claim 14, wherein the corrective action comprises isolating the user device by at least one of blocking traffic to and a traffic from the user device over the mobile network.

17. The method of claim 12, wherein identifying a source of the security event comprises:
sending a data inquiry packet comprising an indicia of the identified security event and the unique session identifier to a correlation system configured to correlate the unique session identifier with a unique mobile user identifier.

18. The method of claim 12, wherein identifying a source of the security event comprises:
sending the header portion and the payload of the data packet to a correlation system configured to correlate the unique session identifier with an account holder information of the user device; and
receiving an account holder information of the user device from the correlation system.

19. The method of claim 12, wherein the program comprises:
a user plane analysis component configured to receive user plane traffic and to extract a unique session identifier from the header portion of the data packet;
a control plane analysis component configured to receive control plane user traffic and to inspect the payload for a security event; and
a correlation component configured to correlate the security event and the unique session identifier with a unique user information of the mobile network.

20. The method of claim 19, wherein:
the control plane analysis component is configured to capture control plane traffic on an S5, an S2b, and an S1-MME interface; and
the user plane component is configured to capture user plane traffic on an S2a, the S2b, an S3, an S4, a Gn, an S5, the S1-MME, an S11, and an S8 interface.
